(19) United States
(12) Patent Application Publication
(10) Pub. No.: US 2012/0263016 A1
(43) Pub. Date: Oct. 18, 2012

(54) SEISMIC IMAGING APPARATUS

(76) Inventor: Changsoo Shin, Seoul (KR)

(21) Appl. No.: 13/449,457

(22) Filed: Apr. 18, 2012

Related U.S. Application Data
(60) Provisional application No. 61/476,384, filed on Apr. 18, 2011.

(30) Foreign Application Priority Data
Apr. 18, 2012 (KR) 10-2012-0040259

(51) Int. Cl. G01V 1/28

(52) U.S. Cl. 367/73

(57) ABSTRACT

A technology of imaging a land seismic wave in the Laplace domain is provided. According to an aspect, a plurality of geophones are distributed in a lattice form at a regular interval of 150-250 m over a region to be inspected, and buried in the ground. Each of the geophones is buried in a hole excavated in the ground, and the hole is filled with cement.

### CROSS-REFERENCE TO RELATED APPLICATION(S)

This application claims the benefit under 35 USC. §119 of a U.S. Patent Application No. 61/476,384, filed on Apr. 18, 2011, and Korean Patent Application No. 10-2012-0040259, filed on Apr. 18, 2012, the entire disclosures of which are incorporated herein by reference for all purposes.

### BACKGROUND

1. Field

The following description relates to a land seismic imaging technology for modeling a subsurface structure through waveform inversion in the Laplace domain.

2. Description of the Related Art

Technologies for imaging a subsurface structure through waveform inversion have been studied and developed. An example of such technologies is disclosed in a Korean Patent Registration No. 1,092,668 registered on 5 Dec. 2011, filed on 17 Jun. 2009 with the Korea Intellectual Property Office. The Korean Patent Registration has been filed as U.S. patent application Ser. No. 12/817,799 with the U.S. Patent and Trademark Office.

According to the disclosures, a low-frequency signal from a source is sent to a subsurface structure, a wave reflected from the subsurface structure is measured as measured data by receivers, and then the measured data is used to obtain a modeling parameter of the corresponding subsurface structure. The coefficients of a wave equation consist of modeling parameters such as the density, etc. of the subsurface space to which the wave is propagated. The modeling parameters of the wave equation are calculated by waveform inversion. According to the waveform inversion, the modeling parameters are calculated while being iteratively updated in the direction of minimizing a residual function regarding the difference between modeling data and measured data, wherein the modeling data is a solution of the wave equation.

In a conventional land seismic data acquisition technology, a source is generated from the earth's surface and a wave is detected from receivers arranged in a lattice form on the earth's surface. However, seismic signals are contaminated with source-receiver coupling and also contain the surface wave such as Rayleigh wave, which deteriorates the accuracy of waveform inversion.

### SUMMARY

The following description relates to a land seismic data acquisition method capable of excluding adverse effects due to source-receiver coupling.

In one general aspect, there is provided a seismic imaging apparatus including: a seismic source buried in the ground; a plurality of geophones distributed in a lattice form over a region to be inspected and configured to sense a wave passed through the ground after being generated by the seismic source, wherein each of the geophones is buried in an excavated hole in the ground; a waveform inversion unit configured to obtain a modeling parameter of a wave equation in a Laplace domain by iteratively updating the modeling parameter in the direction of minimizing a residual function regarding an error between modeling data and measured data, wherein the modeling data is a solution of the wave equation to which the modeling parameter has been applied and the measured data has been measured by the geophone; and an imaging unit configured to image a subsurface structure from the modeling parameter.

The excavated hole may be excavated to a depth of 10-20 m in the ground. The excavated hole may be excavated to a depth of 0.2-1.2 m from the surface of the bedrock.

A plurality of excavated holes may be arranged in a lattice form at a regular interval of 150-250 m.

In another general aspect, there is provided a land seismic data acquisition method, including: distributing a plurality of geophones in a lattice form at a regular interval of 150-250 m over a region to be inspected, wherein each of the geophones is buried in a hole excavated in the ground.

The land seismic data acquisition method may further include: excavating a plurality of holes in a lattice form to a depth of 10-20 m in the ground; installing the geophones in the holes, respectively; and filling the holes with cement fully or partially.

The land seismic data acquisition method may further include burying a seismic source in the ground.

The holes may be excavated to a depth of 0.2-1.2 m from the surface of the bedrock.

The seismic source may be installed in a hole excavated to a depth of 10-20 m in the ground.

The hole in which the seismic hole is installed may be excavated to a depth of 0.2-1.2 m from the surface of the bedrock, wherein the depth is shallower than the depth of the holes in which the geophones are installed.

Other features and aspects will be apparent from the following detailed description, the drawings, and the claims.

### BRIEF DESCRIPTION OF THE DRAWINGS

FIG. 1 is a view for explaining a land seismic data acquisition method.

FIG. 2 is a diagram illustrating an example of a land seismic imaging apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

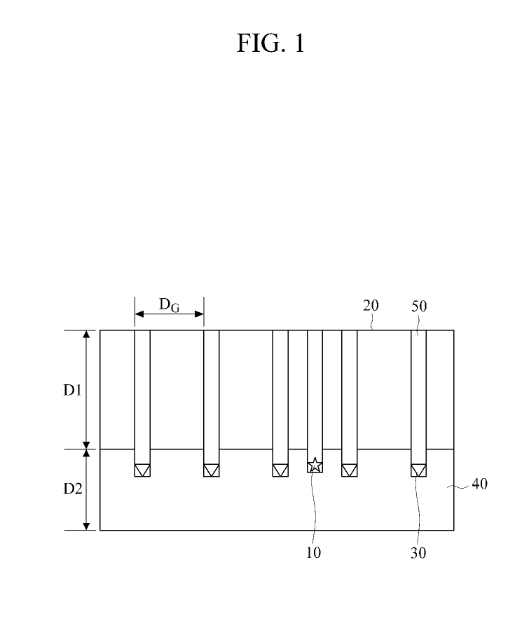

FIG. 1 is a view for explaining a land seismic data acquisition method. As illustrated in FIG. 1, according to an aspect of the land seismic data acquisition method, a plurality of geophones are distributed in a lattice form over a region to be inspected such that the geophones are respectively buried in excavated holes in the ground. The excavated holes are, as shown in the plan view, excavated 2-dimensionally in a lattice form, such as a rectangle shape, a diamond shape, etc. The excavated holes may be excavated at a regular interval D_{G} of 150 to 250 m. Generally, in land seismic survey, geophones are arranged at a regular interval of 10 to 50 m. In waveform inversion in the Laplace domain, increasing the interval between the geophones has little influence on output images. However, in the Laplace domain, sufficiently increasing a measurement time has great influence on the accuracy of output images. For example, the measurement time may be 10 seconds or more. Since the geophones are installed in the excavated holes, not on the earth's surface, adverse effects due to source-receiver coupling can be significantly reduced and the surface wave can be ignored.

According to another aspect, the land seismic data acquisition method includes operations of burying a plurality of excavated holes in a lattice form to a depth D1 of 10-20 m from the earth's surface, of installing a plurality of geophones in the individual excavated holes, and of filling the excavated holes with cement to a predetermined height. Preferably, the excavated holes may be excavated to a depth D2 of 0.2-1.2 m from the surface of the bedrock.

As shown in FIG. 1, the excavated holes are excavated to a depth of 10-20 m in the ground in order to thoroughly exclude adverse effects due to source-receiver coupling. Also, since each of the geophones is installed in a hole excavated to the bedrock, the geophone can more accurately measure a wave. In land seismic survey, the geophone may be a magnetic displacement sensor, an accelerometer sensor, etc. Or, the geophone may be a wireless type sensor having no cable connected thereto.

After the geophones are installed in the excavated holes, cement is filled over the geophones. The excavated holes may be filled with cement fully upto the earth's surface or partially to a predetermined height for cost saving.

According to another aspect, the land seismic data acquisition method may further include operation of burying a seismic source in the ground. A hole in which the seismic source will be buried is excavated when the holes for geophones are excavated. According to an aspect, the seismic source may be installed in an excavated hole at a depth of 10-20 m in the ground. The seismic source may be installed after or before the geophones are installed. According to another aspect, the seismic source may be buried in a hole excavated to the bedrock. The hole in which the seismic source is installed is excavated to a depth of 0.2-1.2 m from the surface of the bedrock, wherein the depth may be shallower than that of the holes in which the geophones are installed.

The seismic source may be dynamite, explosive such as Tovex also known as Seismogel, or a vibration source known as Vibroseis. Also, a method of using an accelerated fall of mass such as a thumper truck may be utilized. In the case where a seismic source is installed in an excavated hole, explosive such as Tovex can be effectively used, however, in this case, environmental effects have to be put into consideration.

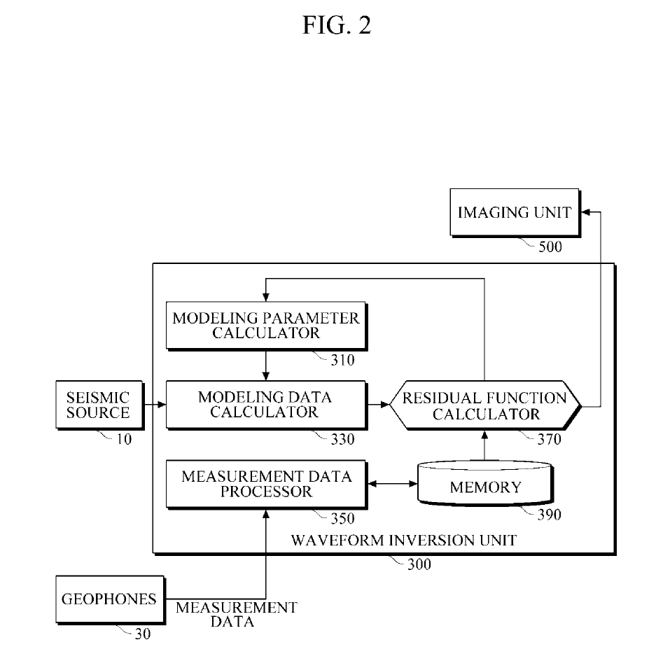

FIG. 2 is a diagram illustrating an example of a land seismic imaging apparatus.

The land seismic imaging apparatus includes a seismic source 10, a plurality of geophones 30, a waveform inversion unit 300, and an imaging unit 500. The seismic source 10 is buried in the ground. The geophones 30 are distributed in a lattice form over a region to be inspected, and sense waves that have passed through the ground after being generated from the seismic source 10. Each of the geophones 30 is buried in an excavated hole in the ground. The geophones 30 have been described above with reference to FIG. 1, and accordingly, a detailed description therefor will be omitted.

The waveform inversion unit 300 obtains a modeling parameter from a wave equation in a Laplace domain by iteratively updating the modeling parameter in the direction of minimizing a residual function regarding an error between modeling data and measured data. Here, the modeling data is a solution of the wave equation to which the modeling parameter has been applied and each of the measured data has been measured by a geophone. The imaging unit 500 is configured to image a subsurface structure from the modeling parameter.

The individual blocks shown in FIG. 2 may be implemented as computer program codes. The blocks may represent functions implemented as program codes, and the meanings and implementation methods of the blocks will be obvious to those skilled in the art. Likewise, as will be easily understood by those skilled in the art, it is apparent that the individual blocks are only functionally distinguished and may be combined or mixed with each other in representation as program codes.

A method of obtaining a space parameter for minimizing a residual by waveform inversion from the wave equation is disclosed in the prior application filed by the same applicant. Modeling parameters are updated in the direction of minimizing a residual function regarding an error between modeling data and measured data, wherein the modeling data is a solution of the wave equation to which the modeling parameters have been applied and the measured data has been measured by a geophone. When the magnitude of the residual function converges to a predetermined value or less, modeling parameter values at that time are output as structural data of the space.

The subsurface structure display unit 500 images a subsurface structure from the modeling parameter obtained by the waveform inversion unit 300. According to another aspect, the subsurface structure display unit 500 may generate and output a color image of the corresponding subsurface structure from the modeling parameter. That is, the subsurface structure display unit 500 may map location-based velocity or density values to different colors to thereby output a color image.

According to another aspect, the waveform inversion unit 300 may include a modeling data calculator 330, a residual function calculator 370, and a modeling parameter calculator 310. The modeling data calculator 330 solves a wave equation in a Laplace domain with given source information, to thereby obtain a solution of the wave equation as modeling data in the Laplace domain. The residual function calculator 370 obtains a residual function regarding a residual between the modeling data and measured data. The modeling parameter calculator 310 updates, if the value of the residual function is greater than a predetermined value, the modeling parameter of the wave equation in the direction of minimizing the residual function and supplies the updated modeling parameter to the modeling data calculator 330, and outputs, if the value of the residual function is smaller than the predetermined value, the modeling parameter as a final output value.

The modeling parameter calculator 310 stores initial parameter values about an initial model of the subsurface structure. The initial parameter values may be arbitrarily set. The modeling data calculator 330 calculates modeling data that can be detected from individual receiving points when waves generated from the equivalent sources are propagated to a subsurface structure defined by the updated modeling parameters. The modeling data may be obtained by solving a wave equation specified by modeling parameters using a numerical analysis method such as a finite difference method or finite element method.

The residual function calculator 370 calculates an error between the measured data stored in a memory 390 and the modeling data calculated from an arbitrary initial model. The residual function may be selected to a L2 norm, a logarithmic norm, a p^{th} power, and an integral value, etc. When the error is greater than a predetermined value, the modeling parameter calculator 310 may update the modeling parameter in the direction of reducing the error. The process is performed by calculating a gradient of a residual function with respect to each model parameter to obtain modeling parameters for minimizing the residual function. When the error is greater than a predetermined value, the modeling parameter is iteratively updated, and when the error is smaller than the predetermined value, the corresponding modeling parameter is determined to a final modeling parameter for the subsurface structure and output. The modeling parameter corresponds to a coefficient of a wave equation, and may be a velocity, density, etc. of the corresponding subsurface space.

Therefore, as described above, since geophones are installed in excavated holes, reverse effects due to source-receiver coupling may be significantly reduced and the surface wave may be ignored.

Further, since the geophones can be arranged at a longer interval than in the conventional technology when the Laplace-domain waveform inversion is applied, the number of required geophones can be reduced, and accordingly, installing cost for data acquisition also can be minimized

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A seismic imaging apparatus comprising:
a seismic source buried in the ground;
a plurality of geophones distributed in a lattice form over a region to be inspected and configured to sense a wave passed through the ground after being generated by the seismic source, wherein each of the geophones is buried in an excavated hole in the ground;
a waveform inversion unit configured to obtain a modeling parameter of a wave equation in a Laplace domain by iteratively updating the modeling parameter in the direction of minimizing a residual function regarding an error between modeling data and measured data, wherein the modeling data is a solution of the wave equation to which the modeling parameter has been applied and the measured data has been measured by the geophone; and
an imaging unit configured to image a subsurface structure from the modeling parameter.

2. The seismic imaging apparatus of claim 1, wherein the waveform inversion unit comprises:
a modeling data calculator configured to solve the wave equation in the Laplace domain with given source data, thereby obtaining a solution of the wave equation as the modeling data;
a residual function calculator configured to obtain a residual function regarding a residual between data obtained from transforming the measured data into the Laplace domain and the modeling data; and
a modeling parameter calculator configured to update, if a value of the residual function is greater than a predetermined value, the modeling parameter of the wave equation in the direction of minimizing the residual function and supply the updated modeling parameter to the modeling data calculator, and to output, if the value of the residual function is smaller than the predetermined value, the modeling parameter as a final output value.

3. The seismic imaging apparatus of claim 1, wherein the excavated hole is excavated to a depth of 10-20 m in the ground.

4. The seismic imaging apparatus of claim 3, wherein the excavated hole is excavated to a depth of 0.2-1.2 m from the surface of the bedrock.

5. The seismic imaging apparatus of claim 1, wherein a plurality of excavated holes are arranged in a lattice form at a regular interval of 150-250 m.

6. A land seismic data acquisition method, comprising:
distributing a plurality of geophones in a lattice form at a regular interval of 150-250 m over a region to be inspected, wherein each of the geophones is buried in a hole excavated in the ground.

7. The land seismic data acquisition method of claim 6, further comprising:
excavating a plurality of holes in a lattice form to a depth of 10-20 m in the ground;
installing the geophones in the holes, respectively; and
filling the holes with cement fully or partially.

8. The land seismic data acquisition method of claim 7, further comprising:
burying a seismic source in the ground.

9. The land seismic data acquisition method of claim 7, wherein the holes are excavated to a depth of 0.2-1.2 m from the surface of the bedrock.

10. The land seismic data acquisition method of claim 8, wherein the seismic source is installed in a hole excavated to a depth of 10-20 m in the ground.

11. The land seismic data acquisition method of claim 7, wherein the hole in which the seismic hole is installed is excavated to a depth of 0.2-1.2 m from the surface of the bedrock, wherein the depth is shallower than the depth of the holes in which the geophones are installed.
